(19) United States
(12) Patent Application Publication
(10) Pub. No.: US 2026/0135155 A1
(43) Pub. Date: May 14, 2026

(54) ELECTRODE ASSEMBLY FOR SOLID STATE BATTERY AND METHOD FOR MANUFACTURING THE SAME

(71) Applicant: SK ON CO., LTD., Seoul (KR)

(72) Inventors: Hyun Seop SHIN, Daejeon (KR); Kyeong Joon KIM, Daejeon (KR); Seung Hwan LEE, Daejeon (KR); Eun Jeong YI, Daejeon (KR)

(21) Appl. No.: 19/346,581

(22) Filed: Oct. 1, 2025

(30) Foreign Application Priority Data
Oct. 4, 2024 (KR) 10-2024-0134915

(51) Int. Cl. H01M 10/0585; H01M 50/46; H01M 50/474; H01M 50/48

(52) U.S. Cl. CPC H01M 10/0585; H01M 50/46; H01M 50/474; H01M 50/48

(57) ABSTRACT

The present disclosure relates to an electrode assembly for an all-solid-state battery and a method of manufacturing the same. The present disclosure relates to an electrode assembly for an all-solid-state battery and the method of manufacturing the same effectively prevent a short circuit between a positive electrode and a negative electrode.

### CROSS-REFERENCE TO RELATED PATENT APPLICATION

The present application claims priority under 35 U.S.C. § 119(a) to Korean patent application number 10-2024-0134915 filed on Oct. 4, 2024, in the Korean Intellectual Property Office, the entire disclosure of which is incorporated by reference herein.

### BACKGROUND OF THE INVENTION

### 1. Field

The present disclosure relates to an electrode assembly for an all-solid-state battery and a method of manufacturing the same, and more particularly, to an electrode assembly for an all-solid-state battery capable of effectively preventing a short circuit between a positive electrode and a negative electrode, and to a method of manufacturing such an electrode assembly.

### 2. Description of the Related Art

Secondary batteries have been widely used from large devices such as automobiles and power storage systems to small devices such as mobile phones, camcorders, and notebook computers.

As the application field of secondary batteries expands, demand for improvement in the safety and performance of secondary batteries has increased. Among secondary batteries, a lithium secondary battery has advantages of high energy density and large capacity per unit area compared to nickel-manganese batteries or nickel-cadmium batteries.

Meanwhile, conventional lithium secondary batteries mostly used a liquid electrolyte composed of organic solvents. Such liquid electrolytes caused problems of leakage from lithium secondary batteries, and leakage of the liquid electrolyte sometimes caused fire.

Accordingly, in order to improve the safety of lithium secondary batteries, interest has recently increased in all-solid-state batteries using a solid electrolyte instead of a liquid electrolyte.

Since an all-solid-state battery includes a solid electrolyte layer between a positive electrode and a negative electrode, it may not include a separator unlike a lithium secondary battery using a liquid electrolyte, and may have higher energy density than a lithium secondary battery using a liquid electrolyte.

However, a general all-solid-state battery is configured such that the solid electrolyte performs roles of both a separator and an electrolyte, but such an all-solid-state battery structure causes high interfacial resistance between an electrode and an electrolyte. Therefore, batteries having a structure without a separate solid electrolyte or separator have been developed. Since such batteries do not include a separator, the positive electrode and the negative electrode may short-circuit, and thus it is necessary to develop an electrode assembly for an all-solid-state battery capable of effectively preventing a short circuit between the positive electrode and the negative electrode.

### SUMMARY OF THE INVENTION

An object of the present disclosure is to provide an electrode assembly for an all-solid-state battery capable of effectively preventing a short circuit caused by contact between a side surface of a positive electrode and a side surface of a negative electrode.

Another object of the present disclosure is to provide a method of manufacturing an electrode assembly for an all-solid-state battery capable of effectively preventing a short circuit caused by contact between a side surface of a positive electrode and a side surface of a negative electrode.

The electrode assembly for an all-solid-state battery and the method of manufacturing the same according to the present disclosure can be widely used in the field of green technologies utilizing batteries such as electric vehicles. In addition, a battery cell manufactured by the electrode assembly for an all-solid-state battery and the method of manufacturing the same according to the present disclosure can be used in eco-friendly electric vehicles, hybrid vehicles, and the like to suppress air pollution and greenhouse gas emissions and to prevent climate change.

As a technical means for achieving the above-described technical objects, an electrode assembly for an all-solid-state battery according to an embodiment of the present disclosure may include: a positive electrode including one surface and another surface perpendicular to a thickness direction; a negative electrode including one surface and another surface perpendicular to the thickness direction; a solid electrolyte layer formed on the one surface and the other surface of the positive electrode, or on the one surface and the other surface of the negative electrode; and an insulating layer coupled to the solid electrolyte layer so as to cover an edge of the solid electrolyte layer and to protrude from the edge of the solid electrolyte layer, wherein the positive electrode and the negative electrode may be alternately stacked with the solid electrolyte layer interposed therebetween, and a plurality of the positive electrodes and a plurality of the negative electrodes may be stacked in the thickness direction.

In addition, the insulating layer may be formed of a porous material in which a plurality of holes are formed so that at least a portion of an edge of the solid electrolyte layer covered with the insulating layer is exposed, and a liquid electrolyte may be impregnated in the plurality of holes.

In addition, the electrode assembly may further include a first insulating film disposed at one end in the thickness direction of the plurality of positive electrodes and the plurality of negative electrodes, and a second insulating film disposed at the other end in the thickness direction of the plurality of positive electrodes and the plurality of negative electrodes, and the first insulating film and the second insulating film may surround the plurality of positive electrodes and the plurality of negative electrodes and may be adhered to each other so that the plurality of positive electrodes and the plurality of negative electrodes are aligned.

In addition, the first insulating film and the second insulating film may surround the plurality of positive electrodes and the plurality of negative electrodes and may be adhered to each other such that at least a portion of each of the positive electrodes and at least a portion of each of the negative electrodes are exposed.

In addition, the insulating layer may be formed of a fiber material.

In addition, the insulating layer may be formed of a nonwoven fabric.

As a technical means for solving the above-described technical objects, a method of manufacturing an electrode assembly for an all-solid-state battery according to an embodiment of the present disclosure may include: a coating of coating at least one of a positive electrode plate and a negative electrode plate with a solid electrolyte layer such that the solid electrolyte layer is disposed between one surface of the positive electrode plate and the other surface of the negative electrode plate, and between the other surface of the positive electrode plate and one surface of the negative electrode plate; a forming of cutting the positive electrode plate to form a plurality of positive electrodes, and cutting the negative electrode plate to form a plurality of negative electrodes; and a stacking of stacking the plurality of positive electrodes and the plurality of negative electrodes in a thickness direction such that the positive electrodes and the negative electrodes are alternately stacked with the solid electrolyte layer interposed therebetween, while coupling an insulating layer to the solid electrolyte layer so as to cover an edge of the solid electrolyte layer and to protrude from the edge of the solid electrolyte layer.

In addition, the insulating layer may be formed of a porous material in which a plurality of holes are formed so that at least a portion of an edge of the solid electrolyte layer covered with the insulating layer is exposed, and the method may further include, after stacking, impregnating a liquid electrolyte into the plurality of holes.

In addition, the method may further include, between stacking and impregnating, aligning the plurality of positive electrodes and the plurality of negative electrodes.

In addition, the aligning may include a first placing of placing a first insulating film at one end in the thickness direction of the plurality of positive electrodes and the plurality of negative electrodes, a second placing of placing a second insulating film at the other end in the thickness direction of the plurality of positive electrodes and the plurality of negative electrodes, and an adhering of adhering the first insulating film and the second insulating film to each other while surrounding the plurality of positive electrodes and the plurality of negative electrodes with the first insulating film and the second insulating film, thereby aligning the plurality of positive electrodes and the plurality of negative electrodes.

In addition, the first insulating film and the second insulating film may surround the plurality of positive electrodes and the plurality of negative electrodes and may be adhered to each other such that at least a portion of each of the positive electrodes and at least a portion of each of the negative electrodes are exposed.

In addition, the insulating layer may be formed of a fiber material.

In addition, the insulating layer may be formed of a nonwoven fabric.

Specific details of other embodiments for solving the problems are included in the description of the invention and the drawings.

According to the means for solving the problems of the present disclosure as described above, the electrode assembly for an all-solid-state battery and the method of manufacturing the same according to the present disclosure provide an effect of effectively preventing a short circuit between a positive electrode and a negative electrode, since the insulating layer covers an edge of the solid electrolyte layer coupled to the positive electrode or the negative electrode so as to protrude from the edge of the solid electrolyte layer.

In addition, since the insulating layer is configured to cover the edge of the solid electrolyte layer adjacent to the insulating layer while being formed to have a plurality of holes into which a liquid electrolyte is impregnated, an effect of minimizing reduction of the contact area between the electrolyte layer and the positive electrode or the negative electrode is provided.

### BRIEF DESCRIPTION OF THE DRAWINGS

FIG. 1 is a schematic view illustrating an electrode assembly for an all-solid-state battery according to an embodiment of the present disclosure.

FIG. 2 is an exploded perspective view schematically illustrating positive electrodes and negative electrodes alternately stacked.

FIG. 3 is a view illustrating an insulating layer formed of a porous material covering an edge of a solid electrolyte layer.

FIG. 4 is a flow chart illustrating a method of manufacturing an electrode assembly for an all-solid-state battery according to an embodiment of the present disclosure.

FIG. 5 is a flow chart illustrating an aligning.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

Throughout the specification, when it is mentioned that a part is “connected” to another part, it includes not only the case where they are “directly connected,” but also the case where they are “electrically connected” with another element in between.

Throughout the specification, when it is mentioned that an element is “on” another element, this includes not only the case where the element is in contact with the other element, but also the case where there is another element between the two elements.

Throughout the specification, when it is mentioned that a part “includes” or “comprises” a component, this does not mean that it excludes other components, but rather that it may include other components, unless otherwise specifically stated. The terms such as “about” and “substantially”, which indicate degrees, as used throughout the specification, are used in a meaning that is at or near a numerical value when manufacturing and material tolerances inherent in the meanings stated are given, and are used to prevent unscrupulous infringers from unfairly exploiting the disclosure, which states precise or absolute numbers to aid understanding of the present disclosure. The terms “step of doing ˜” or “step of ˜” as used throughout the specification do not mean “step for ˜”.

Hereinafter, with reference to the accompanying drawings and the description below, preferred embodiments of the present disclosure are described in detail. However, the present disclosure is not limited to the embodiments described here, but may be embodied in other forms. Throughout the specification, the same reference numerals represent the same components.

Hereinafter, an electrode assembly for an all-solid-state battery according to an embodiment of the present disclosure will be described.

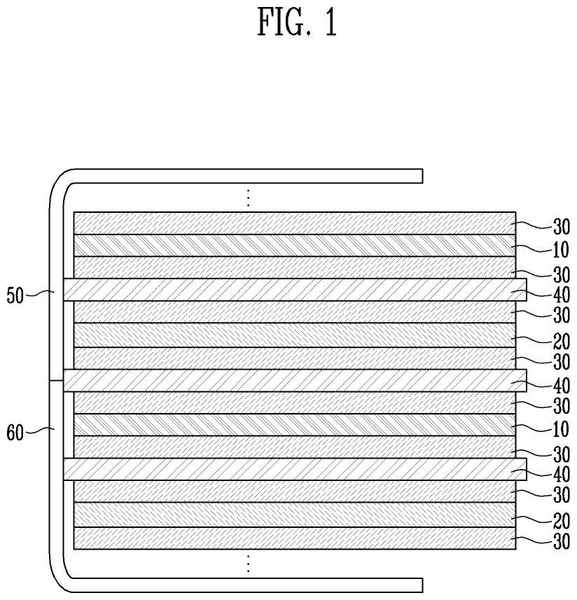

FIG. 1 is a schematic view illustrating an electrode assembly for an all-solid-state battery according to an embodiment of the present disclosure.

Referring to FIG. 1, an electrode assembly 1 for an all-solid-state battery includes a positive electrode 10, a negative electrode 20, a solid electrolyte layer 30, an insulating layer 40, a first insulating film 50, and a second insulating film 60.

First, the positive electrode 10 will be described.

The positive electrode 10 may include a positive electrode active material and a conductive material, and may include one surface and another surface perpendicular to a thickness direction.

The positive electrode active material may be composed of an oxide active material, a sulfide active material, or the like, but the material is not limited thereto.

The conductive material forms an electron conduction path in the positive electrode 10, and may be an sp² carbon material such as carbon black, conducting graphite, ethylene black, carbon nanotube, or the like, or may be graphene.

Next, the negative electrode 20 will be described.

The negative electrode 20 may include a negative electrode active material and a conductive material, and may include one surface and another surface perpendicular to a thickness direction.

The negative electrode active material may be composed of a carbon active material, a metal active material, or the like, but the material is not limited thereto.

The conductive material forms an electron conduction path in the negative electrode 20, and may be an sp² carbon material such as carbon black, conducting graphite, ethylene black, carbon nanotube, or the like, or may be graphene.

As illustrated in FIG. 1, the positive electrode 10 and the negative electrode 20 may be stacked such that a plurality of positive electrodes 10 and a plurality of negative electrodes 20 are alternately stacked with a solid electrolyte layer 30, which will be described below, interposed therebetween, in a predetermined thickness direction.

Next, the solid electrolyte layer 30 will be described.

The solid electrolyte layer 30 may be formed of an oxide-based solid electrolyte or a sulfide-based solid electrolyte, and may be formed on one surface and the other surface of the positive electrode 10, or on one surface and the other surface of the negative electrode 20.

That is, the solid electrolyte layer 30 may be formed by coating or the like on one surface and the other surface of the positive electrode 10 perpendicular to the thickness direction, or may be formed by coating or the like on one surface and the other surface of the negative electrode 20 perpendicular to the thickness direction.

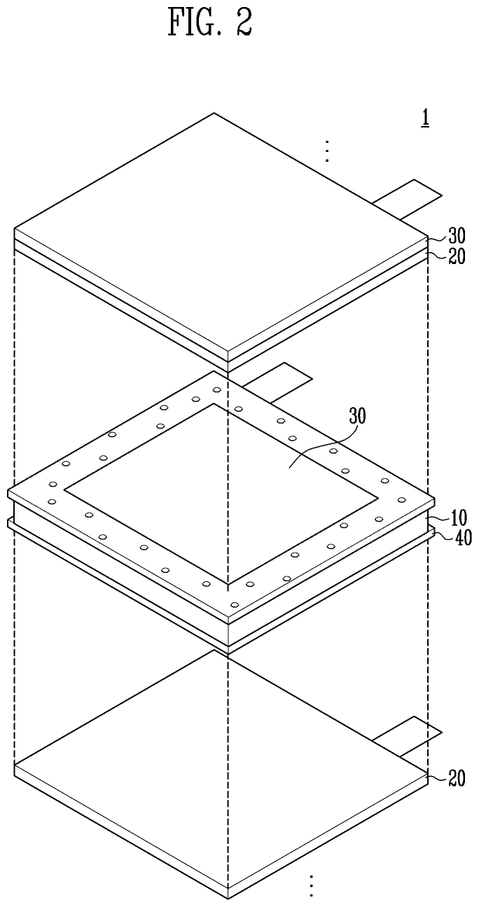

FIG. 2 is an exploded perspective view schematically illustrating positive electrodes and negative electrodes alternately stacked.

For example, as illustrated in FIG. 2, the solid electrolyte layer 30 may be formed only on one surface and the other surface of the positive electrode 10, and the positive electrode 10 covered with the solid electrolyte layer 30 and an insulating layer 40, which will be described below, and the negative electrode 20 on which the solid electrolyte layer 30 is not formed may be alternately stacked.

Meanwhile, although not illustrated in the drawings, the solid electrolyte layer 30 may be formed on both one surface and the other surface of the positive electrode 10 and one surface and the other surface of the negative electrode 20.

Next, the insulating layer 40 will be described.

The insulating layer 40 may be formed of a fiber material. For example, the insulating layer 40 may be formed of a nonwoven fabric, but the material of the insulating layer 40 is not limited thereto.

The insulating layer 40 may be coupled to the solid electrolyte layer 30 so as to protrude from an edge of the solid electrolyte layer 30.

Since the side surface of the positive electrode 10 or the negative electrode 20 on which the solid electrolyte layer 30 is formed does not have the solid electrolyte layer 30, conductive material or the like exposed to the side surface of the positive electrode 10 may short-circuit with conductive material or the like exposed to the side surface of the negative electrode 20 adjacent to the positive electrode 10.

Therefore, when the insulating layer 40 is coupled to the solid electrolyte layer 30 so as to protrude from the edge of the solid electrolyte layer 30, the insulating layer 40 protruding from the edge of the solid electrolyte layer 30 is disposed between the side surface of the positive electrode 10 and the side surface of the negative electrode 20, thereby preventing a short circuit between the positive electrode 10 and the negative electrode 20.

Meanwhile, as illustrated in FIG. 2, the insulating layer 40 is coupled to the solid electrolyte layer 30 so as to cover an edge of the solid electrolyte layer 30.

When the insulating layer 40 is coupled to the solid electrolyte layer 30 so as to cover the edge of the solid electrolyte layer 30 in this manner, the insulating layer 40 is more firmly coupled to the solid electrolyte layer 30, thereby effectively preventing the insulating layer 40 from being detached from a side surface of the positive electrode 10 or the negative electrode 20, and thus significantly improving the effect of preventing a short circuit between the positive electrode 10 and the negative electrode 20.

However, when the insulating layer 40 is configured to cover an edge of the solid electrolyte layer 30 formed on the positive electrode 10 or the negative electrode 20, the contact area between the negative electrode 20 or the positive electrode 10 stacked to contact the positive electrode 10 or the negative electrode 20 on which the solid electrolyte layer 30 is formed and the solid electrolyte layer 30 is reduced.

In order to solve this problem, the insulating layer 40 may be configured to minimize reduction of the contact area between the solid electrolyte layer 30 and the positive electrode 10 or between the solid electrolyte layer 30 and the negative electrode 20.

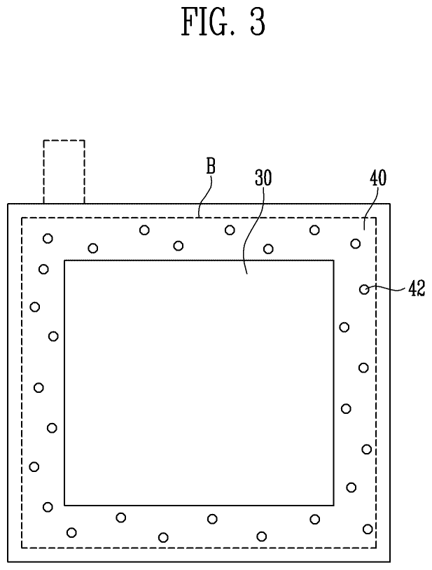

FIG. 3 is a view illustrating an insulating layer formed of a porous material covering an edge of a solid electrolyte layer.

Specifically, as illustrated in FIG. 3, the insulating layer 40 may be formed of a porous material in which a plurality of holes 42 are formed so that at least a portion of an edge of the solid electrolyte layer 30 covered with the insulating layer 40 is exposed.

A liquid electrolyte may be impregnated in the plurality of holes 42 formed in the insulating layer 40.

As such, since the insulating layer 40 is formed of a porous material in which the plurality of holes 42 are formed and the liquid electrolyte is impregnated in the plurality of holes 42, the contact area between the positive electrode 10 or the negative electrode 20 and the electrolyte layer may be expanded by an area corresponding to cross-sectional areas of the plurality of holes 42.

Next, the first insulating film 50 and the second insulating film 60 will be described.

The first insulating film 50 and the second insulating film 60 may be formed of an insulating material.

As illustrated in FIG. 1, the first insulating film 50 may be disposed at one end in the thickness direction of the plurality of positive electrodes 10 and the plurality of negative electrodes 20, and the second insulating film 60 may be disposed at the other end in the thickness direction of the plurality of positive electrodes 10 and the plurality of negative electrodes 20.

The first insulating film 50 and the second insulating film 60 may surround the plurality of positive electrodes 10 and the plurality of negative electrodes 20 and may be adhered to each other so that the plurality of positive electrodes 10 and the plurality of negative electrodes 20 are aligned. The first insulating film 50 and the second insulating film 60 may be adhered to each other through an adhesive, or may be adhered to each other through an adhesive film, but the adhering method between the first insulating film 50 and the second insulating film 60 is not limited thereto.

For example, the first insulating film 50 and the second insulating film 60 may be formed of a laminating film and may be adhered to each other by thermal pressing while surrounding the plurality of positive electrodes 10 and the plurality of negative electrodes 20, but the configuration of the first insulating film 50 and the second insulating film 60 is not limited thereto.

Meanwhile, as illustrated in FIG. 1, the first insulating film 50 and the second insulating film 60 may surround the plurality of positive electrodes 10 and the plurality of negative electrodes 20 and may be adhered to each other such that at least a portion of each of the positive electrodes 10 and at least a portion of each of the negative electrodes 20 are exposed.

When an electrolyte flows in through the exposed portions of the plurality of positive electrodes 10 and the plurality of negative electrodes 20 in this manner, a liquid electrolyte can flow into the plurality of positive electrodes 10 and the plurality of negative electrodes 20, and the liquid electrolyte can be impregnated into the plurality of holes 42 formed in the insulating layer 40.

Hereinafter, a method of manufacturing an electrode assembly for an all-solid-state battery according to an embodiment of the present disclosure will be described.

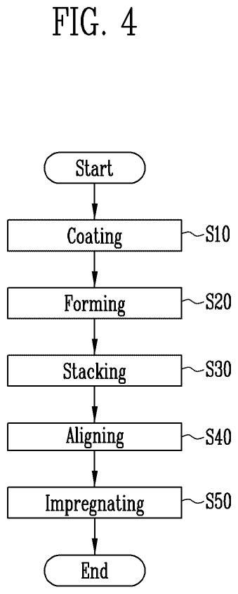

FIG. 4 is a flow chart illustrating a method of manufacturing an electrode assembly for an all-solid-state battery according to an embodiment of the present disclosure.

Referring to FIG. 4, the method of manufacturing an electrode assembly for an all-solid-state battery includes coating S10, forming S20, stacking S30, aligning S40, and impregnating S50.

First, coating S10 will be described.

Coating S10 is a step of coating the positive electrode plate and/or the negative electrode plate with the solid electrolyte layer 30 such that the solid electrolyte layer 30 is disposed between one surface of the positive electrode plate and the other surface of the negative electrode plate, and between the other surface of the positive electrode plate and one surface of the negative electrode plate.

The positive electrode plate is a plate from which the positive electrode 10 can be formed by cutting, and the negative electrode plate is a plate from which the negative electrode 20 can be formed by cutting.

The solid electrolyte layer 30 may be formed of a polymer-based electrolyte, a composite electrolyte in which two or more different electrolytes are mixed, an oxide-based solid electrolyte, or a sulfide-based solid electrolyte, but the material for forming the solid electrolyte layer 30 is not limited thereto.

Meanwhile, the solid electrolyte layer 30 may be formed on both one surface and the other surface of the positive electrode plate and one surface and the other surface of the negative electrode plate.

Next, forming S20 will be described.

Forming S20 is a step of cutting the positive electrode plate to form a plurality of positive electrodes 10, and cutting the negative electrode plate to form a plurality of negative electrodes 20.

The positive electrode 10 may include a positive electrode active material, a conductive material, a solid electrolyte, and a binder.

The positive electrode active material may be composed of an oxide active material, a sulfide active material, or the like, but the material is not limited thereto.

The conductive material forms an electron conduction path in the positive electrode 10, and may be an sp² carbon material such as carbon black, conducting graphite, ethylene black, carbon nanotube, or the like, or may be graphene.

The solid electrolyte may be formed of the same material as the material constituting the solid electrolyte layer 30 described above, but the material for forming the solid electrolyte is not limited thereto.

The binder may serve to improve adhesive strength between the positive electrode active material and the conductive material and the positive electrode 10, and may be composed of a conventional binder.

The negative electrode 20 may include a negative electrode active material, a conductive material, a solid electrolyte, and a binder.

The negative electrode active material may be composed of a carbon active material, a metal active material, or the like, but the material is not limited thereto.

The conductive material forms an electron conduction path in the negative electrode 20, and may be an sp² carbon material such as carbon black, conducting graphite, ethylene black, carbon nanotube, or the like, or may be graphene.

The solid electrolyte may be formed of the same material as the material constituting the solid electrolyte layer 30 described above, but the material for forming the solid electrolyte is not limited thereto.

The binder may serve to improve adhesive strength between the negative electrode active material and the conductive material and the negative electrode 20, and may be composed of a conventional binder.

A solid electrolyte layer 30 is formed on one surface and the other surface of the positive electrode 10 formed by cutting the positive electrode plate, or on one surface and the other surface of the negative electrode 20 formed by cutting the negative electrode plate.

Meanwhile, the solid electrolyte layer 30 may be formed on both one surface and the other surface of the positive electrode 10 formed by cutting the positive electrode plate and one surface and the other surface of the negative electrode 20 formed by cutting the negative electrode plate.

Next, stacking S30 will be described.

Stacking S30 is a step of coupling the insulating layer 40 to the solid electrolyte layer 30 so as to cover an edge of the solid electrolyte layer 30 and to protrude from the edge of the solid electrolyte layer 30, and stacking a plurality of positive electrodes 10 and a plurality of negative electrodes 20 in a thickness direction such that the positive electrodes 10 and the negative electrodes 20 are alternately stacked with the solid electrolyte layer 30 interposed therebetween.

The insulating layer 40 may be formed of a fiber material. For example, the insulating layer 40 may be formed of a nonwoven fabric, but the material of the insulating layer 40 is not limited thereto.

The positive electrode 10 and the negative electrode 20 may be short-circuited through an edge portion of the solid electrolyte layer 30 on which the solid electrolyte layer 30 is not coated in the positive electrode 10 or the negative electrode 20.

At this time, when the insulating layer 40 covers the edge of the solid electrolyte layer 30, a short circuit between the positive electrode 10 and the negative electrode 20 can be prevented.

In addition, since the side surface of the positive electrode 10 or the negative electrode 20 on which the solid electrolyte layer 30 is formed does not have the solid electrolyte layer 30, conductive material or the like exposed to the side surface of the positive electrode 10 may be short-circuited with conductive material or the like exposed to the side surface of the negative electrode 20 adjacent to the positive electrode 10.

Therefore, when the insulating layer 40 is coupled to the solid electrolyte layer 30 so as to protrude from an edge of the solid electrolyte layer 30, the insulating layer 40 protruding from the edge of the solid electrolyte layer 30 is disposed between a side surface of the positive electrode 10 and a side surface of the negative electrode 20, thereby preventing a short circuit between the positive electrode 10 and the negative electrode 20.

In addition, since stacking S30 covers the edge of the solid electrolyte layer 30 with the insulating layer 40, the insulating layer 40 is more firmly coupled to the solid electrolyte layer 30, thereby effectively preventing the insulating layer 40 from being detached from the side surface of the positive electrode 10 or the negative electrode 20, and significantly improving the effect of preventing a short circuit between the positive electrode 10 and the negative electrode 20.

However, when the edge of the solid electrolyte layer 30 formed on the positive electrode 10 or the negative electrode 20 is covered with the insulating layer 40, the contact area between the negative electrode 20 or the positive electrode 10 stacked to contact the positive electrode 10 or the negative electrode 20 on which the solid electrolyte layer 30 is formed and the solid electrolyte layer 30 is reduced.

In order to solve this problem, the insulating layer 40 may be configured to minimize reduction of the contact area between the solid electrolyte layer 30 and the positive electrode 10 or between the solid electrolyte layer 30 and the negative electrode 20.

Specifically, as described in the electrode assembly 1 for an all-solid-state battery according to an embodiment of the present disclosure, the insulating layer 40 may be formed of a porous material in which a plurality of holes 42 are formed so that at least a portion of an edge of the solid electrolyte layer 30 covered with the insulating layer 40 is exposed.

A liquid electrolyte may be impregnated in the plurality of holes 42 formed in the insulating layer 40.

As such, since the insulating layer 40 has the plurality of holes 42 formed therein and the liquid electrolyte is impregnated in the plurality of holes 42, the contact area between the positive electrode 10 or the negative electrode 20 and the electrolyte layer may be expanded by an area corresponding to cross-sectional areas of the plurality of holes 42.

After the insulating layer 40 is coupled to the solid electrolyte layer 30, a plurality of positive electrodes 10 and a plurality of negative electrodes 20 may be stacked in a thickness direction such that the positive electrodes 10 and the negative electrodes 20 are alternately stacked with the solid electrolyte layer 30 interposed therebetween.

Next, aligning S40 will be described.

Aligning S40 is a step of aligning the plurality of positive electrodes 10 and the plurality of negative electrodes 20 stacked.

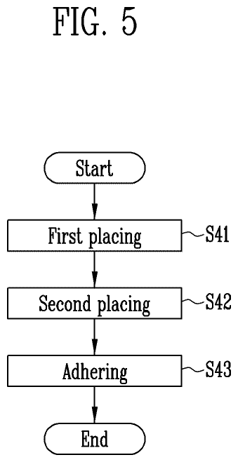

FIG. 5 is a flow chart illustrating an aligning.

Specifically, referring to FIG. 5, aligning S40 is a step of aligning the plurality of positive electrodes 10 and the plurality of negative electrodes 20, and may include a first placing S41, a second placing S42, and an adhering S43.

The first placing S41 is a step of placing a first insulating film 50 at one end in the thickness direction of the plurality of positive electrodes 10 and the plurality of negative electrodes 20.

The first insulating film 50 may be formed of an insulating material. For example, the first insulating film 50 may be formed of a laminating film, but the configuration of the first insulating film 50 is not limited thereto.

The second placing S42 is a step of placing a second insulating film 60 at the other end in the thickness direction of the plurality of positive electrodes 10 and the plurality of negative electrodes 20.

The second insulating film 60 may be formed of an insulating material. For example, the second insulating film 60 may be formed of a laminating film, but the configuration of the second insulating film 60 is not limited thereto.

The adhering S43 is a step of surrounding the plurality of positive electrodes 10 and the plurality of negative electrodes 20 with the first insulating film 50 and the second insulating film 60 and adhering the first insulating film 50 and the second insulating film 60 to each other, thereby aligning the plurality of positive electrodes 10 and the plurality of negative electrodes 20. The first insulating film 50 and the second insulating film 60 may be adhered to each other through an adhesive, or may be adhered to each other through an adhesive film, but the adhering method between the first insulating film 50 and the second insulating film 60 is not limited thereto.

For example, the adhering S43 may be performed by thermally pressing the first insulating film 50 and the second insulating film 60, which are formed of a laminating film and surround the plurality of positive electrodes 10 and the plurality of negative electrodes 20, to adhere them to each other.

Meanwhile, as described above in the electrode assembly 1 for an all-solid-state battery according to an embodiment of the present disclosure, the first insulating film 50 and the second insulating film 60 may surround the plurality of positive electrodes 10 and the plurality of negative electrodes 20 and may be adhered to each other such that at least a portion of each of the positive electrodes 10 and at least a portion of each of the negative electrodes 20 are exposed.

Next, impregnating S50 will be described.

Impregnating S50 is a step of impregnating a liquid electrolyte into the plurality of holes 42 formed in the insulating layer 40.

Specifically, in impregnating S50, the liquid electrolyte may be introduced through at least a portion of each of the positive electrodes 10 and at least a portion of each of the negative electrodes 20 exposed to the outside.

As such, when the liquid electrolyte is introduced through at least a portion of each of the positive electrodes 10 and at least a portion of each of the negative electrodes 20 exposed to the outside, the liquid electrolyte can flow into the plurality of positive electrodes 10 and the plurality of negative electrodes 20, and can be impregnated into the plurality of holes 42 formed in the insulating layer 40.

As described above, the electrode assembly for an all-solid-state battery and the method of manufacturing the same according to the present disclosure provide an effect of effectively preventing a short circuit between a positive electrode and a negative electrode, since the insulating layer covers an edge of the solid electrolyte layer coupled to the positive electrode or the negative electrode so as to protrude from the edge of the solid electrolyte layer.

In addition, since the insulating layer is configured to cover an edge of the solid electrolyte layer adjacent to the insulating layer while being formed to have a plurality of holes impregnated with a liquid electrolyte, an effect of minimizing reduction of the contact area between the electrolyte layer and the positive electrode or the negative electrode is provided.

The foregoing description of the present disclosure is for illustrative purposes, and it will be understood by those skilled in the art to which the present disclosure pertains that various modifications can be made in other specific forms without changing the technical spirit or essential characteristics of the present disclosure. Therefore, the embodiments described above are to be understood in all respects as illustrative and not restrictive. For example, each component described as being formed in a single body may be implemented in a distributed form, and likewise, components described as being distributed may also be implemented in a combined form.

The scope of the present disclosure is indicated by the claims below rather than the foregoing detailed description, and it is to be interpreted that all modifications or altered forms derived from the meaning, scope, and equivalents of the claims are included within the scope of the present disclosure.

What is claimed is:

1. An electrode assembly for an all-solid-state battery comprising:
a positive electrode including one surface and another surface perpendicular to a thickness direction;
a negative electrode including one surface and another surface perpendicular to the thickness direction;
a solid electrolyte layer formed on the one surface and the other surface of the positive electrode, or on the one surface and the other surface of the negative electrode; and
an insulating layer coupled to the solid electrolyte layer so as to cover an edge of the solid electrolyte layer and to protrude from the edge of the solid electrolyte layer,
wherein the positive electrode and the negative electrode are alternately stacked with the solid electrolyte layer interposed therebetween, and a plurality of the positive electrodes and a plurality of the negative electrodes are stacked in the thickness direction.

2. The electrode assembly for an all-solid-state battery according to claim 1, wherein the insulating layer is formed of a porous material in which a plurality of holes are formed so that at least a portion of an edge of the solid electrolyte layer covered with the insulating layer is exposed, and
wherein a liquid electrolyte is impregnated in the plurality of holes.

3. The electrode assembly for an all-solid-state battery according to claim 2,
further comprising:
a first insulating film disposed at one end in the thickness direction of the plurality of positive electrodes and the plurality of negative electrodes; and
a second insulating film disposed at the other end in the thickness direction of the plurality of positive electrodes and the plurality of negative electrodes,
wherein the first insulating film and the second insulating film surround the plurality of positive electrodes and the plurality of negative electrodes and are adhered to each other so that the plurality of positive electrodes and the plurality of negative electrodes are aligned.

4. The electrode assembly for an all-solid-state battery according to claim 3, wherein the first insulating film and the second insulating film surround the plurality of positive electrodes and the plurality of negative electrodes and are adhered to each other such that at least a portion of each of the positive electrodes and at least a portion of each of the negative electrodes are exposed.

5. The electrode assembly for an all-solid-state battery according to claim 4, wherein the insulating layer is formed of a fiber material.

6. The electrode assembly for an all-solid-state battery according to claim 5, wherein the insulating layer is formed of a nonwoven fabric.

7. A method of manufacturing an electrode assembly for an all-solid-state battery, comprising:
coating at least one of a positive electrode plate and a negative electrode plate with a solid electrolyte layer such that the solid electrolyte layer is disposed between one surface of the positive electrode plate and the other surface of the negative electrode plate, and between the other surface of the positive electrode plate and one surface of the negative electrode plate;
forming the positive electrode plate to form a plurality of positive electrodes, and forming the negative electrode plate to form a plurality of negative electrodes; and
stacking the plurality of positive electrodes and the plurality of negative electrodes in a thickness direction such that the positive electrodes and the negative electrodes are alternately stacked with the solid electrolyte layer interposed therebetween, while coupling an insulating layer to the solid electrolyte layer so as to cover an edge of the solid electrolyte layer and to protrude from the edge of the solid electrolyte layer.

8. The method of manufacturing an electrode assembly for an all-solid-state battery according to claim 7, wherein the insulating layer is formed of a porous material in which a plurality of holes are formed so that at least a portion of an edge of the solid electrolyte layer covered with the insulating layer is exposed,
and further comprising, after stacking, impregnating a liquid electrolyte into the plurality of holes.

9. The method of manufacturing an electrode assembly for an all-solid-state battery according to claim 8, further comprising, between stacking and impregnating, aligning the plurality of positive electrodes and the plurality of negative electrodes.

10. The method of manufacturing an electrode assembly for an all-solid-state battery according to claim 9, wherein the aligning comprises:
a first placing of placing a first insulating film at one end in the thickness direction of the plurality of positive electrodes and the plurality of negative electrodes;
a second placing of placing a second insulating film at the other end in the thickness direction of the plurality of positive electrodes and the plurality of negative electrodes; and
an adhering of adhering the first insulating film and the second insulating film to each other while surrounding the plurality of positive electrodes and the plurality of negative electrodes with the first insulating film and the second insulating film, thereby aligning the plurality of positive electrodes and the plurality of negative electrodes.

11. The method of manufacturing an electrode assembly for an all-solid-state battery according to claim 10, wherein the first insulating film and the second insulating film surround the plurality of positive electrodes and the plurality of negative electrodes and are adhered to each other such that at least a portion of each of the positive electrodes and at least a portion of each of the negative electrodes are exposed.

12. The method of manufacturing an electrode assembly for an all-solid-state battery according to claim 11, wherein the insulating layer is formed of a fiber material.

13. The method of manufacturing an electrode assembly for an all-solid-state battery according to claim 12, wherein the insulating layer is formed of a nonwoven fabric.
